(19) United States
(12) Patent Application Publication
(10) Pub. No.: US 2026/0254695 A1
(43) Pub. Date: Aug. 27, 2026

(54) HOPPING DESIGN FOR SRS WITH PARTIAL SOUNDED SUB-BAND

(71) Applicant: Samsung Electronics Co., Ltd., Suwon-si (KR)

(72) Inventors: Fan Zhang, Frisco, TX (US); Van Thuy Nguyen, Plano, TX (US); Tiexing Wang, Melissa, TX (US); Yang Li, Plano, TX (US)

(21) Appl. No.: 19/546,096

(22) Filed: Feb. 20, 2026

Related U.S. Application Data
(60) Provisional application No. 63/764,357, filed on Feb. 27, 2025.

(51) Int. Cl. H04L 27/26; H04L 5/00

(52) U.S. Cl. CPC H04L 27/261; H04L 5/0012; H04L 27/26414

(57) ABSTRACT

Apparatuses and methods for a hopping design for a sounding reference signal (SRS) with a partial sounded sub-band. A method performed by a user equipment includes receiving configuration information related to a SRS. The configuration information includes multiple parameters for configuring a frequency hopping pattern for the SRS over time. The method further includes determining, based on the configuration information, a resource allocation for the SRS. The resource allocation provides the SRS with one or more partially sounded sub-bands that implement the frequency hopping pattern. The method further includes transmitting the SRS.

CROSS-REFERENCE TO RELATED AND CLAIM OF PRIORITY

The present application claims priority under 35 U.S.C. § 119 (e) to U.S. Provisional Patent Application No. 63/764,357 filed on Feb. 27, 2025, which is hereby incorporated by reference in its entirety.

### TECHNICAL FIELD

The present disclosure relates generally to wireless communication systems and, more specifically, the present disclosure is related to a hopping design for a sounding reference signa (SRS) with a partial sounded sub-band.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to a hopping design for a SRS with a partial sounded sub-band.

In one embodiment, a user equipment (UE) is provided. The UE includes a transceiver configured to receive configuration information related to a SRS. The configuration information includes multiple parameters for configuring a frequency hopping pattern for the SRS over time. The UE further includes a processor, operably coupled to the transceiver, the processor configured to determine, based on the configuration information, a resource allocation for the SRS. The resource allocation provides the SRS with one or more partially sounded sub-bands that implement the frequency hopping pattern. Furthermore, the transceiver is further configured to transmit the SRS.

In another embodiment, a base station (BS) is provided. The BS includes a transceiver configured to transmit configuration information related to a SRS. The configuration information includes multiple parameters for configuring a frequency hopping pattern for the SRS over time. The BS further includes a processor, operably coupled to the transceiver, the processor configured to determine a resource allocation for the SRS. The resource allocation provides the SRS with one or more partially sounded sub-bands that implement the frequency hopping pattern. Furthermore, the transceiver is further configured to receive the SRS.

In yet another embodiment, a method performed by a user equipment is provided. The method includes receiving configuration information related to a SRS. The configuration information comprises multiple parameters for configuring a frequency hopping pattern for the SRS over time. The method further includes determining, based on the configuration information, a resource allocation for the SRS. The resource allocation provides the SRS with one or more partially sounded sub-bands that implement the frequency hopping pattern. The method further includes transmitting the SRS.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of the configuration parameters for SRS in 5G NR according to embodiments the present disclosure;

FIGS. 7A and 7B illustrate examples of intra-slot hopping with partial sounding of a SRS according to 3GPP Release 18;

FIGS. 8A and 8B illustrate examples of frequency hopping patterns for SRS over slot indices for a single UE/user according to embodiments of the present disclosure;

FIG. 9 illustrates an example multiplexing method for transmitting SRS with partially sounded sub-bands for multiple UEs/users according to embodiments of the present disclosure;

FIGS. 10A and 10B illustrate other examples of frequency hopping patterns for SRS over slot indices for a single UE/user according to embodiments of the present disclosure;

FIG. 11 illustrates another example multiplexing method for transmitting SRS with partially sounded sub-bands for multiple UEs/users according to embodiments of the present disclosure;

FIGS. 12A and 12B illustrate other examples of frequency hopping patterns for SRS over slot indices for a single UE/user according to embodiments of the present disclosure;

FIG. 13 illustrates yet another example multiplexing method for transmitting SRS with partially sounded sub-bands for multiple UEs/users according to embodiments of the present disclosure;

FIGS. 14A and 14B illustrate other examples of frequency hopping patterns for SRS over slot indices for a single UE/user according to embodiments of the present disclosure;

FIG. 15 illustrates yet another example multiplexing method for transmitting SRS with partially sounded sub-bands for multiple UEs/users according to embodiments of the present disclosure; and

FIG. 16 illustrates an example method performed by a UE in a wireless communication system according to embodiments of the present disclosure.

### DETAILED DESCRIPTION

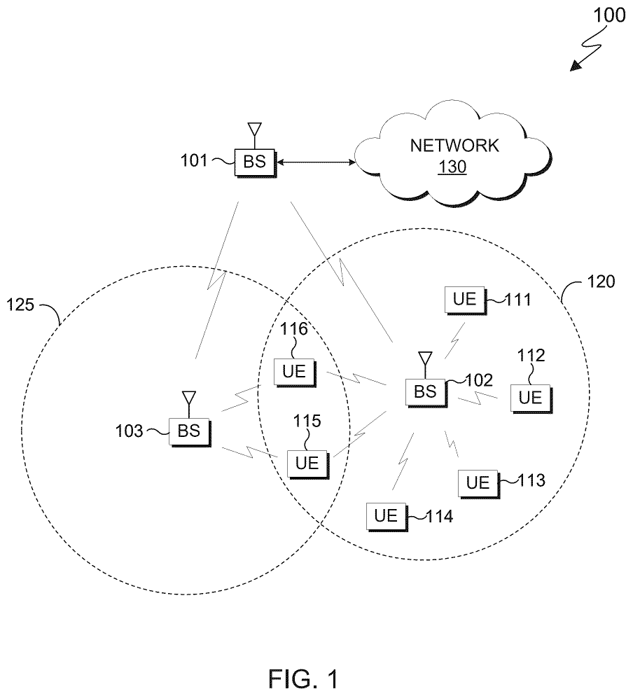

FIGS. 1-16 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: 3GPP TS 38.214 v18.2.0, “NR; Physical layer procedures for data,” Section 6.2.1.1, “UE SRS frequency hopping procedure” (herein, “REF 1”); and 3GPP TS 38.211 v18.2.0, “NR; Physical channels and modulation,” Section 6.4.1.4.3, “Mapping to physical resources” (herein, “REF 2”).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a BS 101 (e.g., base station, eNB, gNB), a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for utilizing a SRS with a partial sounded sub-band that implement a hopping design. In certain embodiments, one or more of the BSs 101-103 include circuitry, programing, or a combination thereof to enable a SRS with a partial sounded sub-band that implement a hopping design.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

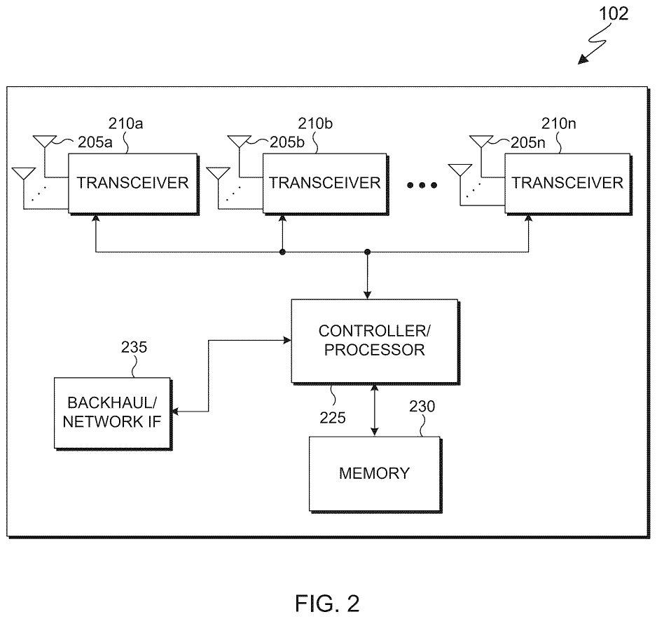

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of the present disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for enabling a SRS with a partial sounded sub-band that implement a hopping design. Any of a wide variety of other functions could be supported in the BS 102 by the controller/processor 225.

The controller/processor 225 is also capable of executing programs and other processes resident in the memory 230, such as processes to enable a SRS with a partial sounded sub-band that implement a hopping design. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2.

Also, various components in FIG. 2 could be combined, further subdivided, or omitted and additional components could be added according to particular needs.

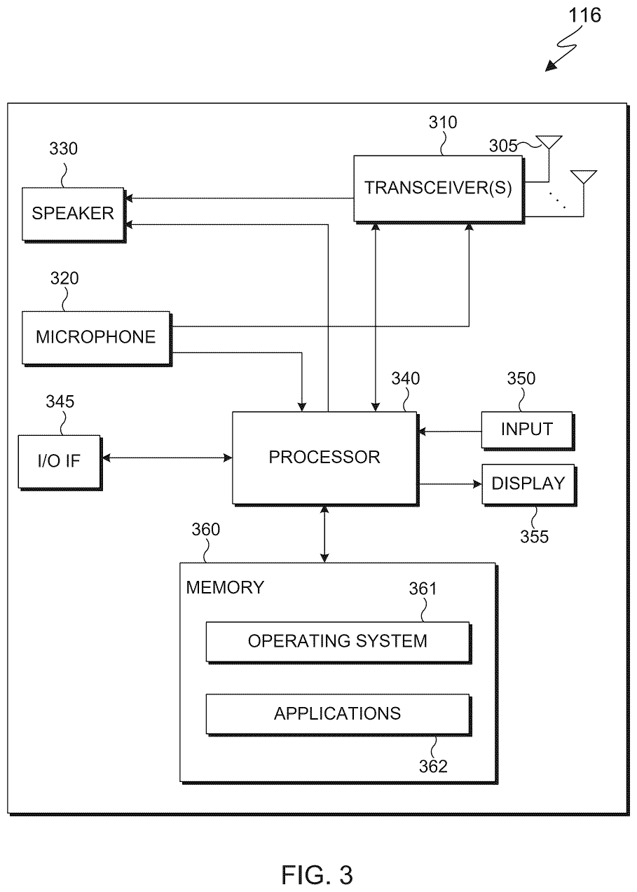

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for performing a SRS transmission with a partial sounded sub-band that implement a hopping design as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

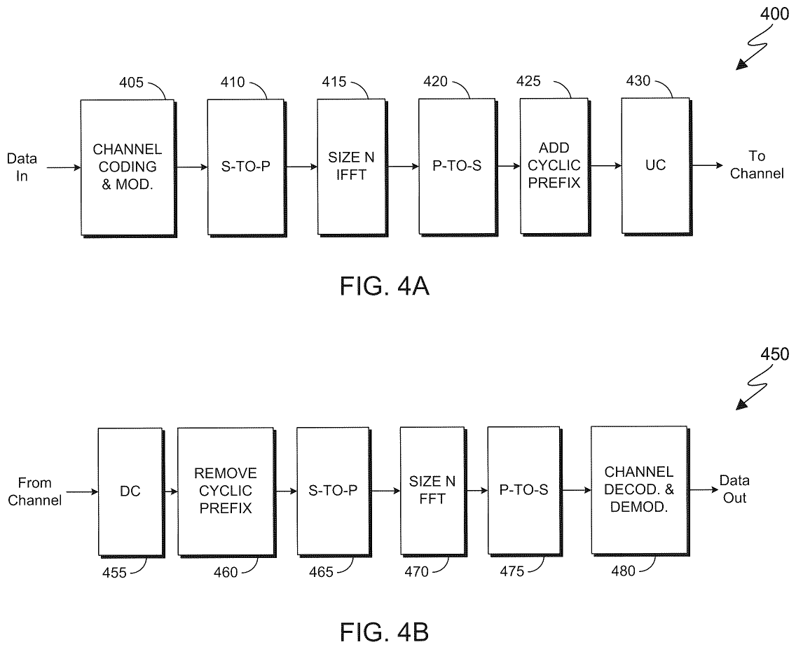

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 and/or the receive path 450 is configured for supporting a SRS with a partial sounded sub-band that implement a hopping design as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the BSs 101-103 and may implement a receive path 450 for receiving in the downlink from the BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

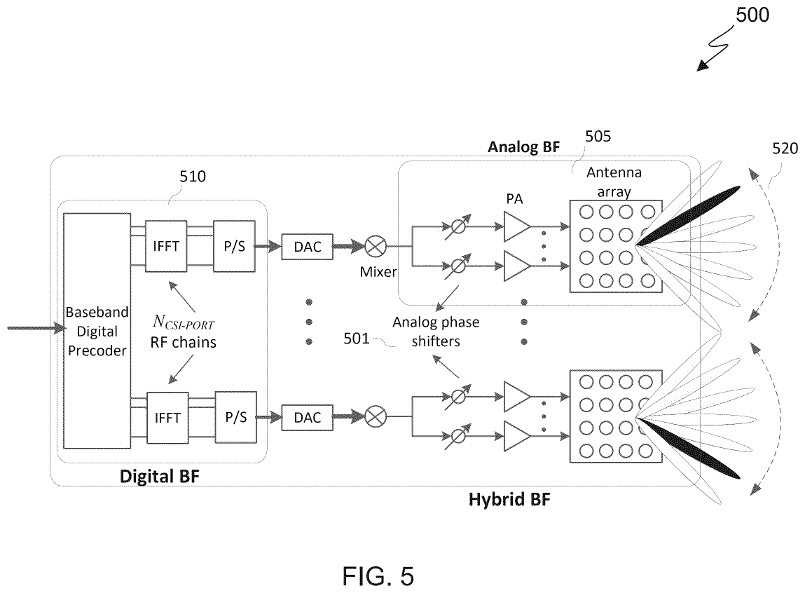

FIG. 5 illustrates an example of a transmitter structure 500 for beamforming according to embodiments of the present disclosure. In certain embodiments, one or more of BS 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NCSI-PORT. A digital beamforming unit 510 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (~10 dB additional loss per 100 m distance), a larger number and narrower analog beams (hence a larger number of radiators in the array) are essential to compensate for the additional path loss.

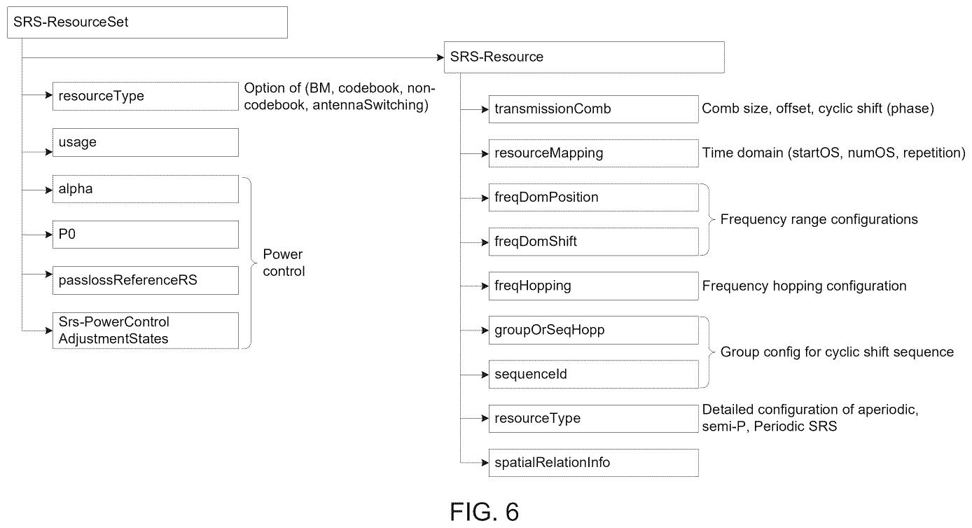

FIG. 6 illustrates an example of the configuration parameters for SRS in 5G NR according to embodiments the present disclosure. For example, these configuration parameters can be defined by BS 102 and implemented by any one the UEs 111-116 of FIG. 1. This example is for illustration only and other embodiments can be used without departing from the scope of the present disclosure.

The configuration of SRS in 5G NR is managed through the radio resource control (RRC) layer, where, as illustrated in FIG. 6, the configuration is organized into two main components: SRS-ResourceSet and SRS-Resource.

SRS-ResourceSet defines the broader group of resources. Key parameters include:
resourceType: Configurations such as Aperiodic (AP), Semi-Persistent (semi-P), and Periodic SRS transmissions.
usage: Supports multiple functionalities, including beam management, codebook-based transmissions, non-codebook usage, and antenna switching.
Power Control: Managed through parameters like alpha, PO, and passlossReferenceRS, with additional control via Srs-PowerControlAdjustmentStates.

SRS-Resource specifies detailed characteristics of each SRS resource. Core parameters include:
transmissionComb: Configures comb size, offset, and cyclic shift (phase) to facilitate efficient resource allocation.
resourceMapping: Controls time domain aspects such as the start symbol, number of symbols, and repetition factor.
freqDomPosition and freqDomShift: Define the frequency domain position and shifts within the bandwidth part (BWP).
freqHopping: Allows frequency hopping configurations across resource blocks (RBs).
groupOrSeqHopp and sequenceId: Enable group and sequence-based cyclic shift configurations.
resourceType: Mirrors the periodicity and offset options found in the SRS-ResourceSet.
spatialRelationInfo: Supports spatial relationships for beam-based SRS transmission.

This robust configuration framework allows the SRS to adapt to varying network conditions, bandwidth allocations, and antenna schemes, enabling 5G NR to deliver enhanced performance in UL coverage, beamforming, and resource management.

In general, SRS is an expensive resource due to its overhead and UE power consumptions. The scheduling of SRS is conservative, which causes a high threshold of scheduling

SRS and limits the usage of SRS. Balance is needed between overhead reduction and SRS quality such as DL channel state information (CSI) accuracy. Current standards which support partial sounding for sub-bands may provide a benefit with regard to overhead reduction. For instance, the partial sounding feature of 3GPP Release 18 makes UE capable of being configured with SRS with intra-slot frequency hopping within a bandwidth part and configured to partially sound on each sub-band. However, the frequency hopping position is currently fixed over time, which can lead to challenges in obtaining high quality observation/estimation of the whole band.

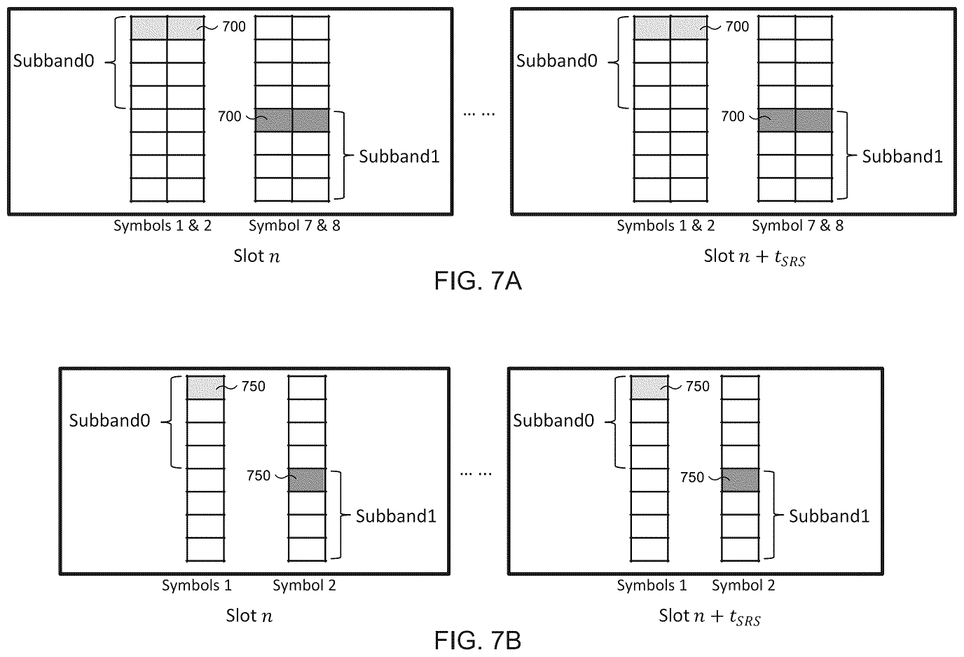

FIGS. 7A and 7B illustrate examples of intra-slot hopping with partial sounding of a SRS according to 3GPP Release 18. For example, the intra-slot hopping and partial sounding can be implemented by any one the UEs 111-116 of FIG. 1 and enabled by BS 102 of FIG. 1. This example is for illustration only and other embodiments can be used without departing from the scope of the present disclosure.

As illustrated in FIG. 7A, the control parameters for SRS may be Nₛ=4, R=2, and P_{F}=4, where the SRS is partially sounded in resource blocks (RBs) 700 over the SRS periodicity t_{SRS}. Alternatively, as illustrated in FIG. 7B, the control parameters for SRS may be Nₛ=4, R=1, and P_{F}=4, where the SRS is partially sounded in resource blocks (RBs) 750 over the SRS periodicity t_{SRS}. Nₛ is the number of symbols, R is the repetition number, and P_{F} is the frequency scaling factor. P_{F} can be 1, 2, or 4 (i.e., P_{F}∈{1, 2, 4}), where 1 means the SRS is sounding at 100% of the assigned band, 2 means the SRS is sounding at 50%, and 4 means the SRS is sounding at 25%. As further illustrated in FIGS. 7A and 7B, the starting point offset corresponding to each sub-band remains the same over time and over different symbols. However, new parameters to control the offset may be introduced to make the offset changeable over symbols and time. Benefits may include making the SRS sounding pattern more flexible, making the SRS overhead reduction easier, and making interpolation/extrapolation possible. Further, more accurate CSI can be obtained via hopping (i.e., incorporating a starting point offset) over all of the partial sounded sub-band, such that position 0, 1, 2, and 3 may be sounded, whereas previously only position 0 was sounded.

The present disclosure provides a frequency hopping over time design for SRS with partially sounded sub-bands. This design includes two parameters to control the hopping order of sub-bands, and therefore enables partial sound hopping over the whole sub-band for better CSI acquisition. More particularly, the present disclosure provides frequency hopping over time for one or more SRSs with one or more partially sounded sub-bands, including using multiple parameters to control a hopping order of the one or more partially sounded sub-bands, and a corresponding multiplexing method. Once again, this may allow partial sound hopping over a particular whole sub-band for improving CSI acquisition.

In various embodiments, sub-band hopping with partial sounding and without intra-slot hopping is provided. In current standards, the StartRBIndex k_{F}∈{0, 1, . . . , P_{F}−1} configures the partial sounding sub-bands start RB index. In the present disclosure, a time-varying parameter computation StartRBIndex is provided, enabling frequency hopping at different slots for different sub-bands.

In such embodiments, a hopping configuration may provide, for example, an additional parameter, StartRBHop h_{F}, and a set, FrequencyHoppingOrder Hₛₑₜ, where H_{Set}={0, 1} for FreqScalingFactor P_{F}=2 and where H_{Set}={0, 2, 1, 3} for P_{F}=4. Note that if P_{F} is configured with other values, H_{Set} can also be adjusted with respect to P_{F}. This hopping configuration may control the hopping position for different partial sounded sub-bands. When h_{F}=0, the UE will perform no frequency hopping over different sub-bands. However, when 0<h_{F}≤P_{F}−1, combined with P_{F}, the hopping position k_{F} (t) at time/slot t is determined as set forth in the procedure below:

```
IF h_{F} = 0,
  k_{F} (t) = k_{F} [no frequency hopping occurs]
ELSE IF 0 < h_{F} ≤ P_{F} − 1,
  k_{F} (t) = (k_{F} + nₚ (t)) mod P_{F},
where the hopping index nₚ (t) = Hₛₑₜ {h_{F} + t}
```

Note that t in the procedure above can be indices of symbols or slots, depending on the specific configurations and purpose. For example, if the purpose is for intra-slot hopping, t is the symbol index.

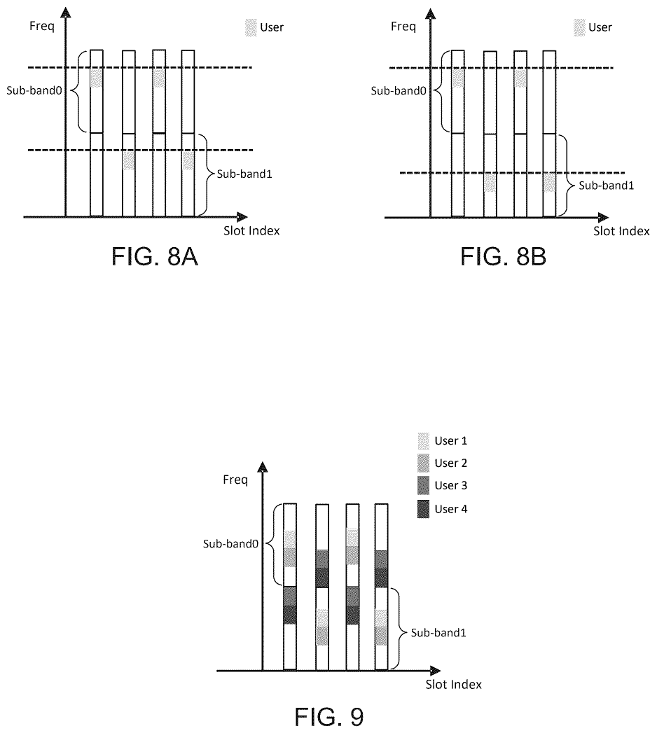

FIGS. 8A and 8B illustrate examples of frequency hopping patterns for SRS over slot indices for a single UE/user according to embodiments of the present disclosure. More particularly, FIG. 8A illustrates a currently available frequency hopping pattern set forth in 3GPP Release 18 and FIG. 8B is a frequency hopping pattern according to embodiments of the present disclosure. For example, the frequency hopping patterns can be defined by BS 102 and implemented by any one the UEs 111-116 of FIG. 1. These examples are for illustration only and other embodiments can be used without departing from the scope of the present disclosure.

As illustrated in FIG. 8A, implementing the currently available frequency hopping pattern when there is no intra-slot hopping results in partially sounded sub-band0 and partially sounded sub-band1 sounding at different times and in the same frequency hopping position within each sub-band (e.g. StartRBIndex k_{F}=1). In other words, while the SRS is partially sounding in each sub-band at different times, the frequency hopping position between sub-bands is the same over time. Note that the exact frequency starting position may be

$${k}_{0}^{( {p}_{i} )} = {\overline{k}}_{0}^{( {p}_{i} )} + {n}_{offset}^{FH} + {n}_{offset}^{RPFS} + {n}_{offset 2}^{FH} ,$$

where

$${n}_{offset}^{RPFS} = {N}_{SC} {m}_{SRS , {B}_{SRS}} ( ( {k}_{F} + {k}_{hop} ) mod {P}_{F} ) / {P}_{F} ,$$

although for purposes of the present disclosure and to illustrate the difference from the current standard, the following examples focus on k_{F} and k_{F}(t), assuming other parameters remain the same. As illustrated in FIG. 8B, implementing a frequency hopping pattern based on the above hopping configuration allows for partially sounded sub-band0 and partially sounded sub-band1 to have different frequency hopping positions over time (i.e., sub-band0 can sound at a particular frequency position within the sub-band and sub-band1 can sound at a different frequency position within the sub-band). To achieve the frequency hopping pattern of FIG. 8B, the hopping configuration parameters may be defined as k_{F}=1 and H_{Set}={0, 1}, which yields k_{F} (t)=1, 2, 1, 2 . . . (i.e., the RB positions of the sub-bands in which the SRS is partially sounded). By implementing at least the frequency hopping pattern illustrated in FIG. 8B, a corresponding multiplexing method may be achieved.

FIG. 9 illustrates an example multiplexing method for transmitting SRS with partially sounded sub-bands for multiple UEs/users according to embodiments of the present disclosure. For example, the multiplexing method can be implemented by any of the UEs 111-116 of FIG. 1 (e.g., UEs 111-114) and enabled by BS 102 of FIG. 1. This example is for illustration only and other embodiments can be used without departing from the scope of the present disclosure.

As illustrated in FIG. 9, the users that fall into different sub-band hopping positions can be directly multiplexed. For example, a first group (e.g., users 1 and 2) and a second group (e.g., users 3 and 4), can be multiplexed independently without collision. Further, the users within the same frequency hopping order, but with a different StartRBIndex, can also be multiplexed. As further illustrated in FIG. 9, users 3 and 4 are sounding in the same sub-band order, but partially sounding at different parts of the sub-band. For user 3, k_{F}=0 and Hₛₑₜ={0, 2}, which yields k_{F}(t)=0, 2, 0, 2, . . . For user 4, k_{F}=1 and Hₛₑₜ={0, 2}, which yields k_{F}(t)=1, 3, 1, 3, . . . For comparison, users 1 and 2 are multiplexed without time varying k_{F}.

In various embodiments, sub-band hopping with partial sounding and with intra-slot hopping is provided. In some embodiments, intra-slot hopped symbols may have the same sub-bandhopping position. In such embodiments, a hopping configuration may provide, for example, an additional parameter, StartRBHop h_{F}, and a set, FrequencyHoppingOrder H_{Set}, where H_{Set}={0, 1} for FreqScalingFactor P_{F}=2 and where H_{Set}={1, 3, 0, 2} for P_{F}=4. Note that if P_{F} is configured with other values, H_{Set} can also be adjusted with respect to P_{F}. This hopping configuration may control the hopping position for different partial sounded sub-bands. When h_{F}=0, the UE will perform no frequency hopping over different sub-bands. However, when 0<h_{F}≤P_{F}−1, combined with P_{F}, the hopping position k_{F}(t) at time/slot t is determined as set forth in the procedure below:

```
IF h_{F} = 0,
  k_{F} (t) = k_{F} [no frequency hopping occurs]
ELSE IF 0 < h_{F} ≤ P_{F} − 1,
  k_{F} (t) = (k_{F} + nₚ (t)) mod P_{F},
where the hopping index nₚ (t) = Hₛₑₜ {h_{F} + t}
```

Note that t in the procedure above can be indices of symbols or slots, depending on the specific configurations and purpose. For example, if the purpose is for intra-slot hopping, t is the symbol index.

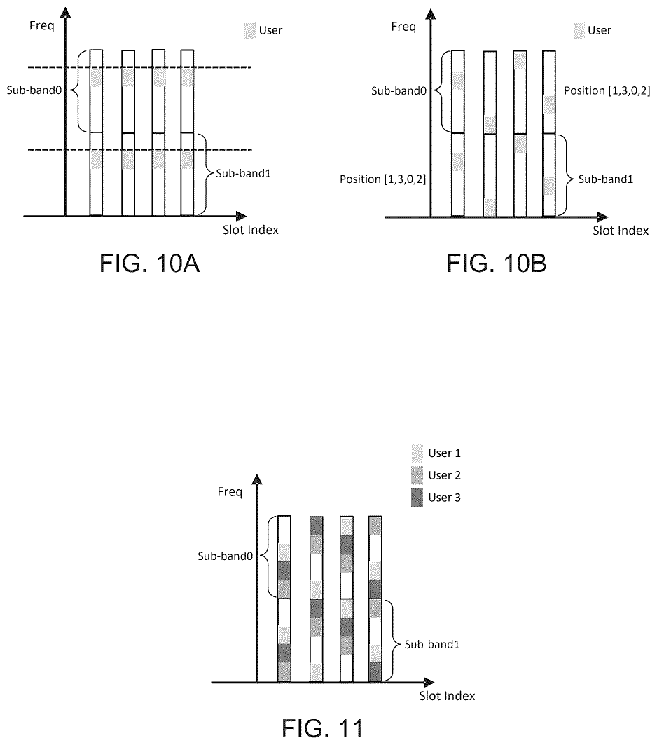

FIGS. 10A and 10B illustrate examples of frequency hopping patterns for SRS over slot indices for a single UE/user according to embodiments of the present disclosure. More particularly, FIG. 10A illustrates, once again, a currently available frequency hopping pattern set forth in 3GPP Release 18 and FIG. 10B is a frequency hopping pattern according to embodiments of the present disclosure. For example, the frequency hopping patterns can be defined by BS 102 and implemented by any one the UEs 111-116 of FIG. 1. These examples are for illustration only and other embodiments can be used without departing from the scope of the present disclosure.

As illustrated in FIG. 10A, implementing the currently available frequency hopping pattern when there is intra-slot hopping and the intra-slot hopped symbols have the same sub-band hopping position results in partially sounded sub-band0 and partially sounded sub-band1 sounding at the same time and in the same frequency hopping position within each sub-band (e.g. StartRBIndex k_{F}=1). Note that the exact frequency starting position may be

$${k}_{0}^{( {p}_{i} )} = {\overline{k}}_{0}^{( {p}_{i} )} + {n}_{offset}^{FH} + {n}_{offset}^{RPFS} + {n}_{offset 2}^{FH} ,$$

where

$${n}_{offset}^{RPFS} = {N}_{SC} {m}_{SRS , {B}_{SRS}} ( ( {k}_{F} + {k}_{hop} ) mod {P}_{F} ) / {P}_{F} ,$$

although for purposes of the present disclosure and to illustrate the difference from the current standard, the following examples focus on k_{F} and k_{F}(t), assuming other parameters remain the same. As illustrated in FIG. 10B, implementing a frequency hopping pattern based on the above hopping configuration allows for partially sounded sub-band0 and partially sounded sub-band1 to each have different frequency hopping positions over time, but the same frequency hopping pattern between sub-bands (i.e., sub-band0 can sound at various frequency positions within the sub-band over time and sub-band1 can also sound at various frequency positions within the sub-band over time and the frequency hopping pattern between sub-band0 and sub-band1 can be the same). To achieve the frequency hopping pattern of FIG. 10B, the hopping configuration parameters may be defined as k_{F}=0 and H_{Set}={1, 3, 0, 2}, which yields k_{F}(t)=1, 3, 0, 2, 1, 3, 0, 2 . . . (i.e., the RB positions of each sub-band in which the SRS is partially sounded). By implementing at least the frequency hopping pattern illustrated in FIG. 10B, a corresponding multiplexing method may be achieved.

FIG. 11 illustrates an example multiplexing method for transmitting SRS with partially sounded sub-bands for multiple UEs/users according to embodiments of the present disclosure. For example, the multiplexing method can be implemented by any of the UEs 111-116 of FIG. 1 (e.g., UEs 111-113) and enabled by BS 102 of FIG. 1. This example is for illustration only and other embodiments can be used without departing from the scope of the present disclosure.

As illustrated in FIG. 11, the users that fall into different sub-band hopping positions can be directly multiplexed. For example, the users within the same frequency hopping order, but with a different StartRBIndex, can automatically be multiplexed. As further illustrated in FIG. 11, users 1, 2, and 3 are sounding the full band signal, but partially sounding at different parts of each sub-band over time. For user 1, k_{F}=0 and Hₛₑₜ={1, 3, 0, 2}, which yields k_{F}(t)=1, 3, 0, 2, . . . For user 2, k_{F}=2 and Hₛₑₜ={1, 3, 0, 2}, which yields k_{F}(t)=3, 1, 2, 0, . . . For user 3, k_{F}=1 and Hₛₑₜ={1, 3, 0, 2}, which yields k_{F}(t)=2, 0, 1, 3, . . .

In other embodiments, intra-slot hopped symbols may have different sub-band hopping positions. In such embodiments, the StartRBIndex k_{F} will vary over different sub-bands, denoted as k_{F}ⁱ for sub-band i. Further, a hopping configuration may provide, for example, an additional parameter, StartRBHop h_{F}, and a set, FrequencyHoppingOrder H_{Set}, where H_{Set}={0, 1} for FreqScalingFactor P_{F}=2 and where H_{Set}={{1, 3, 0, 2}, {0, 2, 1, 3}} for P_{F}=4. Note that if P_{F} is configured with other values, H_{Set} can also be adjusted with respect to P_{F}. This hopping configuration may control the hopping position for different partial sounded sub-bands. When h_{F}=0, the UE will perform no frequency hopping over different sub-bands. However, when 0<h_{F}≤P_{F}−1, combined with P_{F}, the hopping position k_{F}ⁱ(t) at time/slot t is determined as set forth in the procedure below:

```
LOOP all sub-band i
  IF h_{F} = 0,
    kⁱ_{F} (t) = kⁱ_{F} [no frequency hopping occurs]
  ELSE IF 0 < h_{F} ≤ P_{F} − 1,
    kⁱ_{F} (t) = (kⁱ_{F} + nₚ (t)) mod P_{F},
  where the hopping index nₚ (t) = Hₛₑₜ {h_{F} + t}
```

Note that t in the procedure above can be indices of symbols or slots, depending on the specific configurations and purpose. For example, if the purpose is for intra-slot hopping, t is the symbol index.

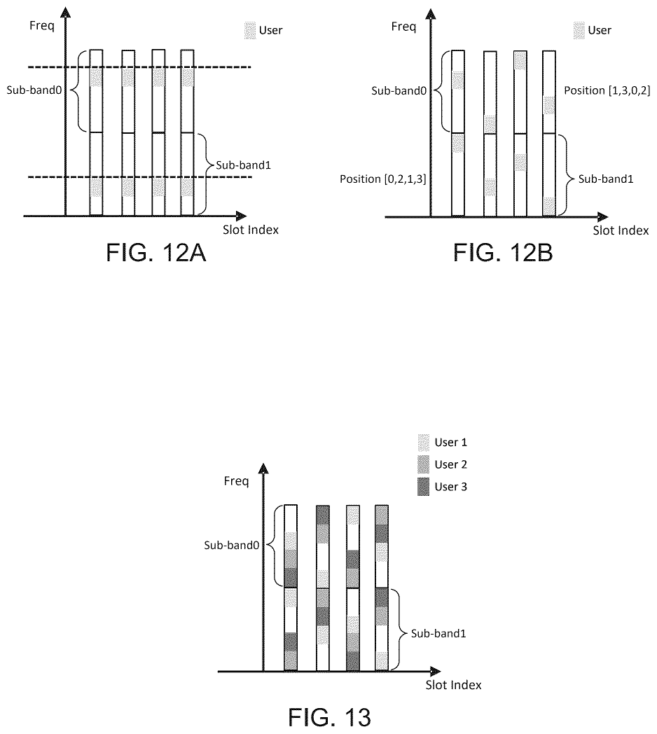

FIGS. 12A and 12B illustrate examples of frequency hopping patterns for SRS over slot indices for a single UE/user according to embodiments of the present disclosure. More particularly, FIG. 12A illustrates, once again, a currently available frequency hopping pattern set forth in 3GPP Release 18 and FIG. 12B is a frequency hopping pattern according to embodiments of the present disclosure. For example, the frequency hopping patterns can be defined by BS 102 and implemented by any one the UEs 111-116 of FIG. 1. These examples are for illustration only and other embodiments can be used without departing from the scope of the present disclosure.

As illustrated in FIG. 12A, implementing the currently available frequency hopping pattern when there is intra-slot hopping and the intra-slot hopped symbols have different sub-band hopping position results in partially sounded sub-band0 and partially sounded sub-band1 sounding at the same time and in different frequency hopping position within each sub-band (e.g. StartRBIndex k_{F}=1). Note that the exact frequency starting position may be

$${k}_{0}^{( {p}_{i} )} = {\overline{k}}_{0}^{( {p}_{i} )} + {n}_{offset}^{FH} + {n}_{offset}^{RPFS} + {n}_{offset 2}^{FH} ,$$

where

$${n}_{offset}^{RPFS} = {N}_{SC} {m}_{SRS , {B}_{SRS}} ( ( {k}_{F} + {k}_{hop} ) mod {P}_{F} ) / {P}_{F} ,$$

although for purposes of the present disclosure and to illustrate the difference from the current standard, the following examples focus on k_{F} and k_{F}(t), assuming other parameters remain the same. As illustrated in FIG. 12B, implementing a frequency hopping pattern based on the above hopping configuration allows for partially sounded sub-band0 and partially sounded sub-band1 to each have different frequency hopping positions over time as well as different frequency hopping patterns between sub-bands (i.e., sub-band0 can sound at various frequency positions within the sub-band over time and sub-band1 can also sound at various frequency positions within the sub-band over time and the frequency hopping pattern between sub-band and sub-band1 is different). In such embodiments, the different frequency hopping patterns between sub-bands can be based on cyclic-shifted frequency hopping over symbols. To achieve the frequency hopping pattern of FIG. 12B, the hopping configuration parameters may be defined as k_{F}=0,

$${H}_{Set}^{0} = \{ 1 , 3 , 0 , 2 \} , and {H}_{Set}^{1} = \{ 0 , 2 , 1 , 3 \} ,$$

where

$${H}_{Set}^{0} and {H}_{Set}^{1}$$

are, for example, cyclically-shifted by 2. This yields

$${k}_{F}^{0} ( t ) = 1 , 3 , 0 , 2 , 1 , 3 , 0 , 2 … and {k}_{F}^{1} ( t ) = 0 , 2 , 1 , 3 , 0 , 2 , 1 , 3 …$$

(i.e., the RB positions of sub-band0 and sub-band1, respectively, in which the SRS is partially sounded). By implementing at least the frequency hopping pattern illustrated in FIG. 12B, a corresponding multiplexing method may be achieved.

FIG. 13 illustrates an example multiplexing method for transmitting SRS with partially sounded sub-bands for multiple UEs/users according to embodiments of the present disclosure. For example, the multiplexing method can be implemented by any of the UEs 111-116 of FIG. 1 (e.g., UEs 111-113) and enabled by BS 102 of FIG. 1. This example is for illustration only and other embodiments can be used without departing from the scope of the present disclosure.

As illustrated in FIG. 13, the users that fall into different sub-band hopping positions can be directly multiplexed. For example, the users that have the same different frequency hopping pattern between sub-bands StartRBIndex, can automatically be multiplexed. As further illustrated in FIG. 13, users 1, 2, and 3 are sounding the full band signal, but partially sounding at different parts of each sub-band over time. For user 1,

$${k}_{F} = 0 , {H}_{set}^{0} = \{ 1 , 3 , 0 , 2 \} , and {H}_{set}^{1} = \{ 0 , 2 , 1 , 3 \} ,$$

which yields

$${k}_{F}^{0} ( t ) = 1 , 3 , 0 , 2 , 1 , 3 , 0 , 2 … and {k}_{F}^{1} ( t ) = 0 , 2 , 1 , 3 , 0 , 2 , 1 , 3 …$$

For user 2,

$${k}_{F} = 0 , {H}_{set}^{0} = \{ 2 , 1 , 3 , 0 \} , and {H}_{set}^{1} = \{ 3 , 0 , 2 , 1 \} ,$$

which yields

$${k}_{F}^{0} ( t ) = 2 , 1 , 3 , 0 , 2 , 1 , 3 , 0 … and {k}_{F}^{1} ( t ) = 3 , 0 , 2 , 1 , 3 , 0 , 2 , 1 …$$

For user 3, k_{F}=0,

$${H}_{set}^{0} = \{ 3 , 0 , 2 , 1 \} , and {H}_{set}^{1} = \{ 2 , 1 , 3 , 0 \} ,$$

which yields

$${k}_{F}^{0} ( t ) = 3 , 0 , 2 , 1 , 3 , 0 , 2 , 1 … and {k}_{F}^{1} ( t ) = 2 , 1 , 3 , 0 , 2 , 1 , 3 , 0 …$$

For all 3 users, the cyclic shift of the frequency hopping patterns between sub-bands is 2.

In other such embodiments, where intra-slot hopped symbols have different sub-band hopping positions, a hopping configuration may provide, for example, an additional parameter, StartRBHop h_{F}, and a set, Frequency HoppingOrder H_{Set}, where H_{Set}={0, 1} for FreqScalingFactor P_{F}=2 and where H_{Set}={{1, 3, 0, 2}, {0, 3, 1, 2}} for P_{F}=4. Note that if P_{F} is configured with other values, H_{Set} can also be adjusted with respect to P_{F}. This hopping configuration may control the hopping position for different partial sounded sub-bands. When h_{F}=0, the UE will perform no frequency hopping over different sub-bands. However, when 0<h_{F}≤P_{F}−1, combined with P_{F}, the hopping position k_{F}ⁱ(t) at time/slot t is determined as set forth in the procedure below:

```
LOOP all sub-band i
  IF h_{F} = 0,
    kⁱ_{F} (t) = kⁱ_{F} [no frequency hopping occurs]
  ELSE IF 0 < h_{F} ≤ P_{F} − 1,
    kⁱ_{F} (t) = (kⁱ_{F} + nₚ (t)) mod P_{F},
  where the hopping index nₚ (t) = Hₛₑₜ {Iₕₒₚ} {h_{F} + t}
```

Note that t in the procedure above can be indices of symbols or slots, depending on the specific configurations and purpose. For example, if the purpose is for intra-slot hopping, t is the symbol index.

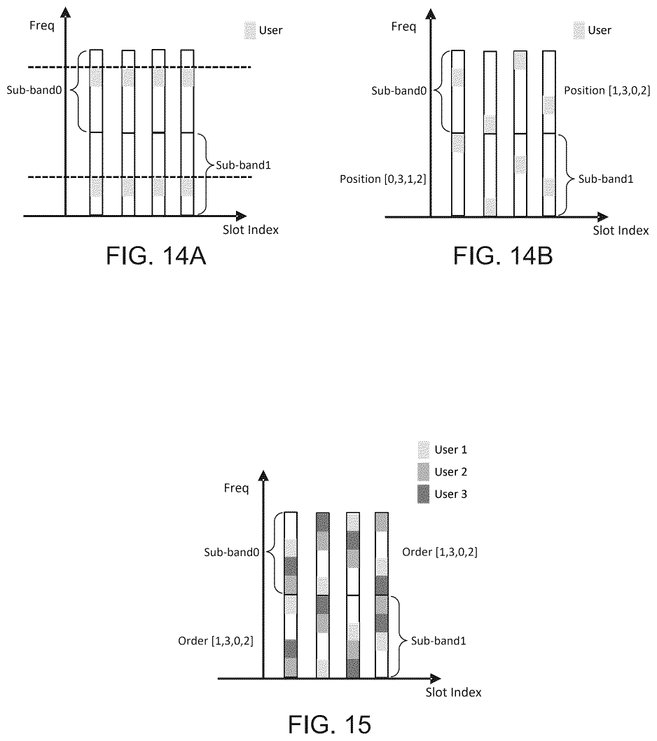

FIGS. 14A and 14B illustrate examples of frequency hopping patterns for SRS over slot indices for a single UE/user according to embodiments of the present disclosure. More particularly, FIG. 14A illustrates, once again, a currently available frequency hopping pattern set forth in 3GPP Release 18 and FIG. 14B is a frequency hopping pattern according to embodiments of the present disclosure. For example, the frequency hopping patterns can be defined by BS 102 and implemented by any one the UEs 111-116 of FIG. 1. These examples are for illustration only and other embodiments can be used without departing from the scope of the present disclosure.

As illustrated in FIG. 14A, implementing the currently available frequency hopping pattern when there is intra-slot hopping and the intra-slot hopped symbols have different sub-band hopping position results in partially sounded sub-band0 and partially sounded sub-band1 sounding at the same time and in different frequency hopping position within each sub-band (e.g. StartRBIndex k_{F}=1). Note that the exact frequency starting position may be

$${k}_{0}^{\{ {p}_{i} \}} = {\overline{k}}_{0}^{\{ {p}_{i} \}} + {n}_{offset}^{FH} + {n}_{offset}^{RPFS} + {n}_{offset 2}^{FH} , where {n}_{offset}^{RPFS} = \frac{{N}_{SC} {m}_{SRS , {B}_{SRS}} ( ( {k}_{F} + {k}_{hop} ) ) mod {P}_{F}}{{P}_{F}} ,$$

although for purposes of the present disclosure and to illustrate the difference from the current standard, the following examples focus on k_{F} and k_{F}(t), assuming other parameters remain the same. As illustrated in FIG. 14B, implementing a frequency hopping pattern based on the above hopping configuration allows for partially sounded sub-band0 and partially sounded sub-band1 to each have different frequency hopping positions over time as well as different frequency hopping patterns between sub-bands (i.e., sub-band0 can sound at various frequency positions within the sub-band over time and sub-band1 can also sound at various frequency positions within the sub-band over time and the frequency hopping pattern between sub-band0 and sub-band1 is different). In such embodiments, the different frequency hopping patterns between sub-bands can be independent of each other (i.e., independent hopping over symbols). To achieve the frequency hopping pattern of FIG. 14B, the hopping configuration parameters may be defined as

$${k}_{F}^{0} = 0 , {k}_{F}^{1} = 0 , {H}_{Set}^{0} = \{ 1 , 3 , 0 , 2 \} , and {H}_{Set}^{1} = \{ 0 , 2 , 1 , 3 \} ,$$

where

$${H}_{Set}^{0} and {H}_{Set}^{1}$$

are, for example, independently hopping over symbols. This yields

$${k}_{F}^{0} ( t ) = 1 , 3 , 0 , 2 , 1 , 3 , 0 , 2 … and {k}_{F}^{1} ( t ) = 0 , 3 , 1 , 2 , 0 , 3 , 1 , 2 …$$

(i.e., the RB positions of sub-band0 and sub-band1, respectively, in which the SRS is partially sounded). By implementing at least the frequency hopping pattern illustrated in FIG. 14B, a corresponding multiplexing method may be achieved.

FIG. 15 illustrates an example multiplexing method for transmitting SRS with partially sounded sub-bands for multiple UEs/users according to embodiments of the present disclosure. For example, the multiplexing method can be implemented by any of the UEs 111-116 of FIG. 1 (e.g., UEs 111-113) and enabled by BS 102 of FIG. 1. This example is for illustration only and other embodiments can be used without departing from the scope of the present disclosure.

As illustrated in FIG. 15, the users that fall into different sub-band hopping positions can be directly multiplexed. For example, since the frequency hopping patterns between sub-bands are independent, the users that have matching frequency hopping patterns for all sub-bands can automatically be multiplexed. As further illustrated in FIG. 15, users 1, 2, and 3 are sounding the full band signal, but partially sounding at different parts of each sub-band over time. For user 1,

$${k}_{F}^{0} = 0 , {H}_{set}^{0} = \{ 1 , 3 , 0 , 2 \} , {k}_{F}^{1} = 0 and {H}_{set}^{1} = \{ 0 , 3 , 1 , 2 \} ,$$

which yields

$${k}_{F}^{0} ( t ) = 1 , 3 , 0 , 2 , 1 , 3 , 0 , 2 … and {k}_{F}^{1} ( t ) = 0 , 3 , 1 , 2 , 0 , 3 , 1 , 2 …$$

For user 2,

$${k}_{F}^{0} = 2 , {H}_{set}^{0} = \{ 1 , 3 , 0 , 2 \} , {k}_{F}^{1} = 0 , and {H}_{set}^{1} = \{ 3 , 1 , 2 , 0 \} ,$$

which yields

$${k}_{F}^{0} ( t ) = 3 , 1 , 2 , 0 , 3 , 1 , 2 , 0 … and {k}_{F}^{1} ( t ) = 3 , 1 , 2 , 0 , 3 , 1 , 2 , 0 …$$

For user 3,

$${k}_{F}^{0} = 1 , {H}_{set}^{0} = \{ 1 , 3 , 0 , 2 \} , {k}_{F}^{1} = 0 , and {H}_{set}^{1} = \{ 2 , 0 , 3 , 1 \} ,$$

which yields

$${k}_{F}^{0} ( t ) = 2 , 0 , 1 , 3 , 2 , 0 , 1 , 3 … and {k}_{F}^{1} ( t ) = 2 , 0 , 3 , 1 , 2 , 0 , 3 , 1 …$$

For all 3 users, the frequency hopping pattern of sub-band0 is all [1, 3, 0, 2] or its cyclic shift, and the frequency hopping pattern for sub-band1 is all [0, 3, 1, 2] or its cyclic shift.

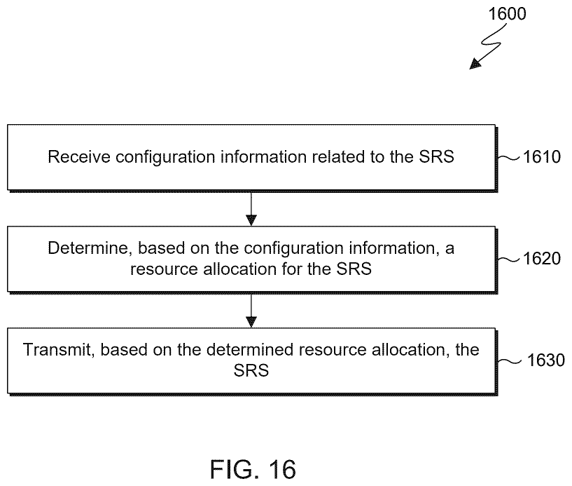

FIG. 16 illustrates an example method 1600 performed by a UE in a wireless communication system according to embodiments of the present disclosure. The method 1600 of FIG. 16 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1600 is for illustration only and other embodiments can be used without departing from the scope of the present disclosure.

The method 1600 begins with receiving configuration information related to a SRS (1610). In various embodiments, the configuration information may comprise multiple parameters for configuring a frequency hopping pattern for the SRS over time. The UE then determines, based on the configuration information, a resource allocation for the SRS (1620). In various embodiments, the resource allocation provides the SRS with one or more partially sounded sub-bands that implement the frequency hopping pattern. The UE then transmits, based on the determined resource allocation, the SRS (1630).

Although FIG. 16 illustrates one example method 1600 of the actions taken by the UE to transmit the SRS based on the configuration information received from the BS, various changes may be made to FIG. 16. For example, while shown as a series of steps, various steps in FIG. 16 could overlap, occur in parallel, occur in a different order, or occur any number of times.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive configuration information related to a sounding reference signal (SRS), wherein the configuration information comprises multiple parameters for configuring a frequency hopping pattern for the SRS over time; and
a processor, operably coupled to the transceiver, the processor configured to determine, based on the configuration information, a resource allocation for the SRS,
wherein the resource allocation provides the SRS with one or more partially sounded sub-bands that implement the frequency hopping pattern, and
wherein the transceiver is further configured to transmit the SRS.

2. The UE of claim 1, wherein the frequency hopping pattern is configured to provide partial sound hopping of the SRS over an entire sub-band.

3. The UE of claim 1, wherein the multiple parameters comprise:
a starting position parameter configured to provide a starting resource index for the one or more partially sounded sub-bands;
a frequency hopping parameter configured to provide whether SRS frequency hopping occurs; and
a frequency hopping order set configured to provide a frequency hopping order among the one or more partially sounded sub-bands, wherein the frequency hopping order is based on the starting position parameter.

4. The UE of claim 3, wherein the multiple parameters further comprise a second starting position parameter, a second frequency hopping parameter, and a second frequency hopping order set for configuring the frequency hopping pattern for individual sub-bands.

5. The UE of claim 1, wherein the frequency hopping pattern is configured to provide the SRS at different hopping positions between the one or more partially sounded sub-bands when there is no SRS intra-slot frequency hopping.

6. The UE of claim 1, wherein the frequency hopping pattern is configured to provide the SRS in a particular hopping order that is common between the one or more partially sounded sub-bands when there is SRS intra-slot frequency hopping.

7. The UE of claim 1, wherein the frequency hopping pattern is configured to provide the SRS in a particular hopping order that is cyclically shifted between the one or more partially sounded sub-bands when there is SRS intra-slot frequency hopping.

8. A base station (BS) comprising:
a transceiver configured to transmit configuration information related to a sounding reference signal (SRS), wherein the configuration information comprises multiple parameters for configuring a frequency hopping pattern for the SRS over time; and
a processor, operably coupled to the transceiver, the processor configured to determine a resource allocation for the SRS,
wherein the resource allocation provides the SRS with one or more partially sounded sub-bands that implement the frequency hopping pattern, and
wherein the transceiver is further configured to receive the SRS.

9. The BS of claim 8, wherein the frequency hopping pattern is configured to provide partial sound hopping of the SRS over an entire sub-band.

10. The BS of claim 8, wherein the multiple parameters comprise:
a starting position parameter configured to provide a starting resource index for the one or more partially sounded sub-bands;
a frequency hopping parameter configured to provide whether SRS frequency hopping occurs; and
a frequency hopping order set configured to provide a frequency hopping order among the one or more partially sounded sub-bands, wherein the frequency hopping order is based on the starting position parameter.

11. The BS of claim 10, wherein the multiple parameters further comprise a second starting position parameter, a second frequency hopping parameter, and a second frequency hopping order set for configuring the frequency hopping pattern for individual sub-bands.

12. The BS of claim 8, wherein the frequency hopping pattern is configured to provide the SRS at different hopping positions between the one or more partially sounded sub-bands when there is no SRS intra-slot frequency hopping.

13. The BS of claim 8, wherein the frequency hopping pattern is configured to provide the SRS in a particular hopping order that is common between the one or more partially sounded sub-bands when there is SRS intra-slot frequency hopping.

14. The BS of claim 8, wherein the frequency hopping pattern is configured to provide the SRS in a particular hopping order that is cyclically shifted between the one or more partially sounded sub-bands when there is SRS intra-slot frequency hopping.

15. A method performed by a user equipment, the method comprising:
receiving configuration information related to a sounding reference signal (SRS), wherein the configuration information comprises multiple parameters for configuring a frequency hopping pattern for the SRS over time;
determining, based on the configuration information, a resource allocation for the SRS, wherein the resource allocation provides the SRS with one or more partially sounded sub-bands that implement the frequency hopping pattern; and
transmitting the SRS.

16. The method of claim 15, wherein the frequency hopping pattern is configured to provide partial sound hopping of the SRS over an entire sub-band.

17. The method of claim 15, wherein the multiple parameters comprise:
a starting position parameter configured to provide a starting resource index for the one or more partially sounded sub-bands;
a frequency hopping parameter configured to provide whether SRS frequency hopping occurs; and
a frequency hopping order set configured to provide a frequency hopping order among the one or more partially sounded sub-bands, wherein the frequency hopping order is based on the starting position parameter.

18. The method of claim 17, wherein the multiple parameters further comprise a second starting position parameter, a second frequency hopping parameter, and a second frequency hopping order set for configuring the frequency hopping pattern for individual sub-bands.

19. The method of claim 15, wherein the frequency hopping pattern is configured to provide the SRS at different hopping positions between the one or more partially sounded sub-bands when there is no SRS intra-slot frequency hopping.

20. The method of claim 15, wherein the frequency hopping pattern is configured to provide the SRS in a particular hopping order that is common between the one or more partially sounded sub-bands when there is SRS intra-slot frequency hopping.
